(19) United States
(12) Patent Application Publication
(10) Pub. No.: US 2013/0022413 A1
(43) Pub. Date: Jan. 24, 2013

(54) Food Grade USDA Abrasive Media System

(71) Applicant: Robert Richard Matthews, Washington, DC (US)

(72) Inventor: Robert Richard Matthews, Washington, DC (US)

(21) Appl. No.: 13/426,602

(22) Filed: Mar. 22, 2012

Related U.S. Application Data
(63) Continuation-in-part of application No. 13/184,508, filed on Jul. 18, 2011.

(51) Int. Cl. B65G 53/40

(52) U.S. Cl. 406/122

(57) ABSTRACT

The Food Grade USDA Abrasive Media System is an aqueous slurry Food Grade USDA abrasive media or FDA Approved aqueous slurry toothpaste formula system, or differential pressurized variable control regulation closed-type Food Grade USDA abrasive media or FDA Approved toothpaste formula system. The aqueous slurry type system pumps aqueous slurry media from an aqueous slurry pump. The differential pressurized variable control regulation closed-type system utilizes negative pressurized air or drawing the media from a control valve. The hallmark of The Food Grade USDA Abrasive Media System is light and easy to operate opening the door to whole new market of customers to safely perform paint stripping and cleaning tasks. Efficiency of operation is acquired by way of diffusion, equal particle distribution, and the effective Food Grade USDA Abrasive Media System can compete against harmful paint thinners, petroleum distillates, and chemical cleaners.

### DOMESTIC PRIORITY DATA

This is an application a continuation in part preliminary amendment to specification application Ser. No. 13/184,508 Filing Date Jul. 18, 2011.

### BACKGROUND OF THE INVENTION

The Food Grade USDA Abrasive Media System is a replacement for hazardous materials solvents, paint thinners, and chemicals. Solvents or petroleum distillates and paint thinners are categorized as carcinogens and hazardous materials. The Food Grade USDA Abrasive Media System is designed to safely clean parts and remove paint by mechanical means as opposed to hazardous chemicals.

Many of the abrasive hoppers on the market today are bulky, heavy, and are hard to operate. The Food Grade USDA Abrasive Media System is light and easy to use, opening the door to whole new market of customers to safely perform paint stripping and cleaning tasks.

### BRIEF SUMMARY OF THE INVENTION

The Food Grade USDA Abrasive Media System is simple in design, light, and easy to operate for many specific cleaning, coating removal applications. This system should find success as environmentally and health conscious consumers become aware of the risks of using hazardous materials. In addition to the consumer market this system can be applied to automotive and aerospace paint stripping industry providing and environmental incentive for business that is change for the better. The Food Grade USDA Abrasive Media System can apply FDA Approved toothpaste patents filed separately for dental and oral care subject to The American Dental Association ADA Seal of Acceptance Program.

### BRIEF DESCRIPTION OF THE SEVERAL VIEWS OF THE DRAWING FOLLOWS FIGS. 1 TO 12

FIG. 1—Food Grade abrasive media airtight plastic injection molded preformed gravity feed free flow hopper comprising lid with release valve, air filter, silica gel slots, and filtered air gravity feed outlet sizes may vary;

FIG. 2—Fine Food Grade abrasive media airtight plastic injection molded preformed gravity feed float free flow hopper comprising lid with release valve, air filter, silica gel slots, and filtered air top feed outlet sizes may vary;

FIG. 3—Differential Pressurized Variable Control Regulation Abrasive Media System;

FIG. 4—Differential Pressurized Variable Control Regulation Abrasive Media One Stage System;

FIG. 5—Zero Nozzle Aqueous Slurry System vertical alignment , or standard alignment shape nozzle measured in diameter not shown here;

FIG. 6—Parallel Phase Differential Pressurized Variable Control Regulation Abrasive Media System;

FIG. 7—Standard nozzle measured in diameter sizes may vary with fine water suppressor;

FIG. 8—Encapsulated pressurized nozzle with fine water suppressor;

FIG. 9—Alternating encapsulated pressurized nozzle with fine water suppressor;

FIG. 10—Zero Encapsulated Nozzle Differential Pressurized Variable Control Regulation Abrasive Media System;

FIG. 11—Zero Standard Nozzle Differential Pressurized Variable Control Regulation Abrasive Media System; and

FIG. 12—Differential Pressurized Variable Control Regulation Abrasive Media System with 4× expansion of Control Valve.

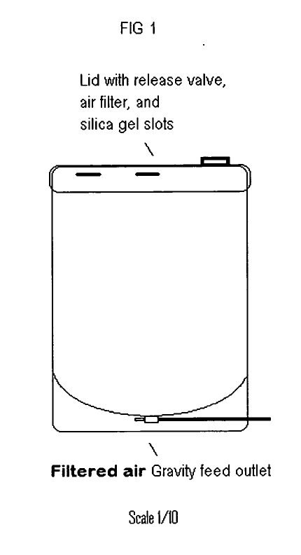

### DETAILED DESCRIPTION OF THE DRAWINGS FIGS. 1 TO 12

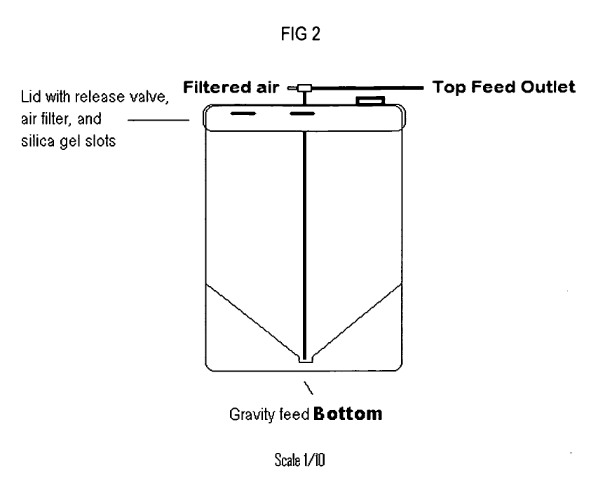

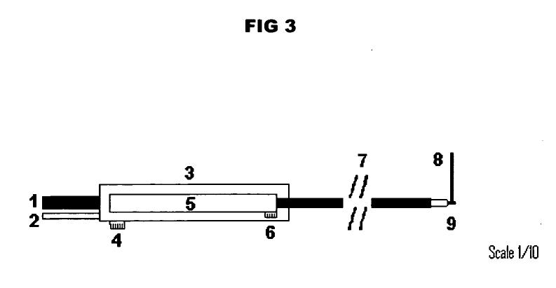

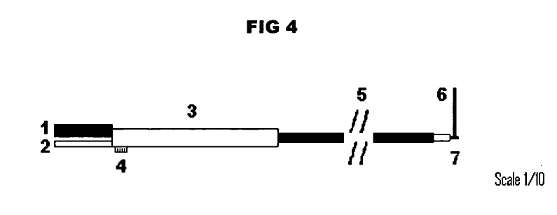

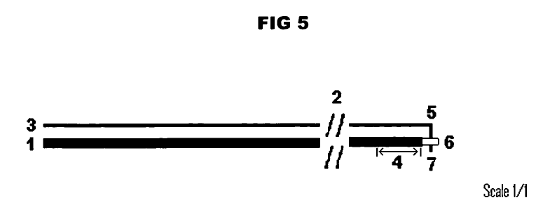

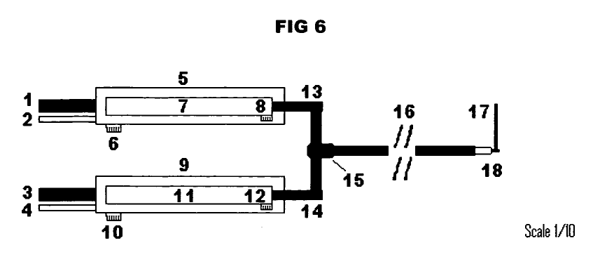

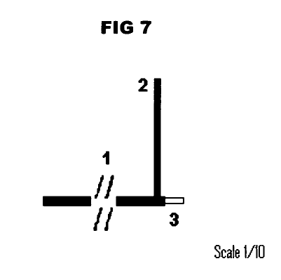

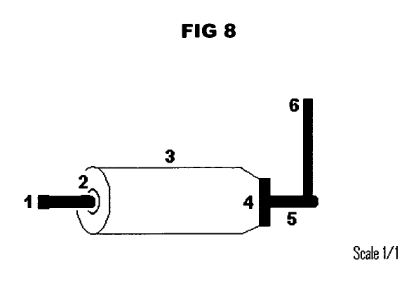

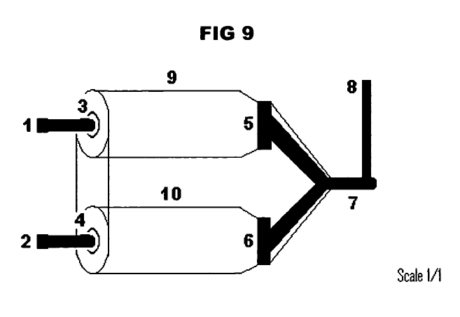

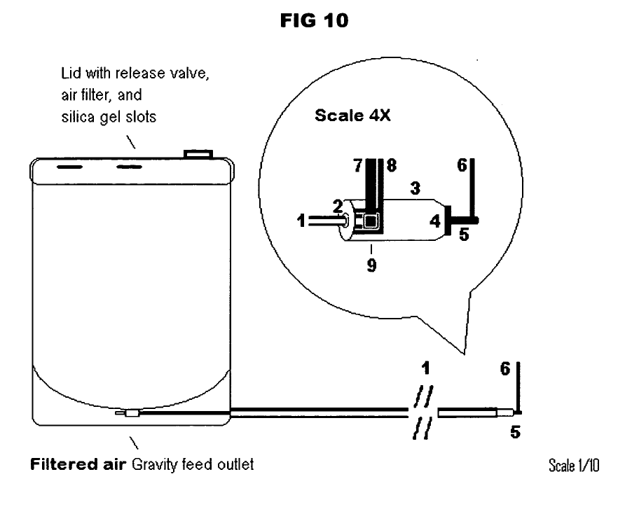

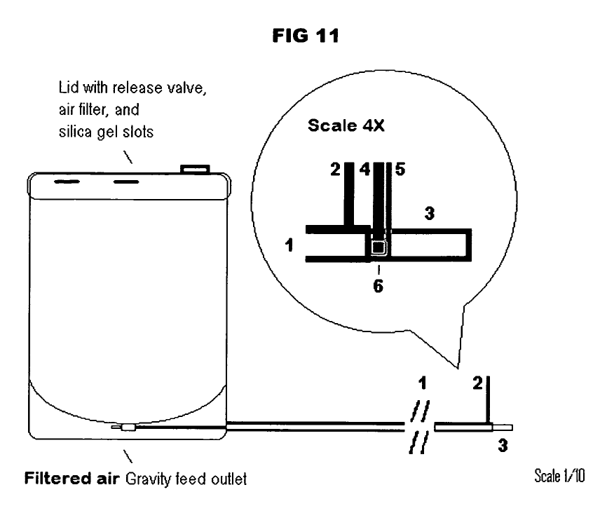

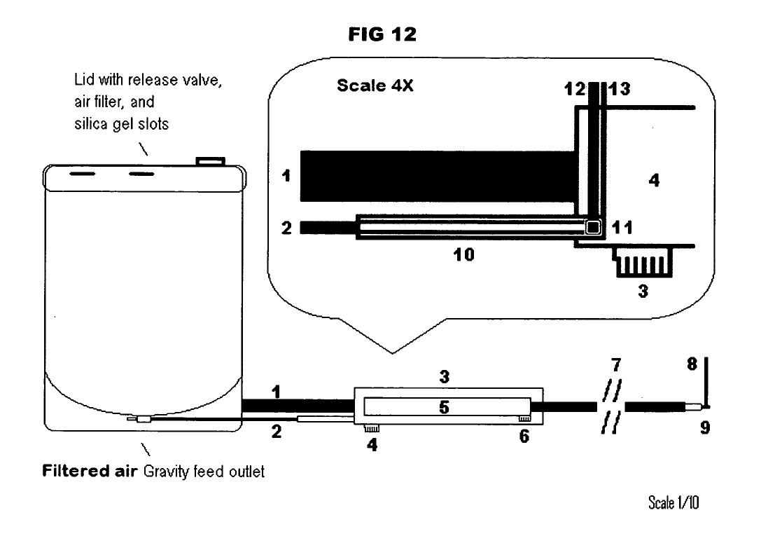

FIG. 1—Lid with release valve, air filter, silica gel slots, and filtered air gravity feed outlet, FIG. 2—Lid with release valve, air filter, silica gel slots, filtered air top feed outlet, and gravity feed bottom, FIG. 3—1—Compressed air hose line-in measured in diameter, 2—Abrasive media hose line-in measured in diameter, 3—Outer pressurized chamber, 4—Variable control regulator, 5—Inner pressurized chamber, 6—Variable control regulator, 7—Compressed air and abrasive media hose line-out measured in diameter, 8—Water hose line-in measured in diameter fine water suppressor water ring or water ring delimited, and 9—Encapsulated nozzle, FIG. 4—1—Compressed air hose line-in measured in diameter, 2—Abrasive media hose line-in measured in diameter, 3—Stage one pressurized chamber, 4—Variable control regulator, 5—Compressed air and abrasive media hose line-out measured in diameter, 6—Water hose line-in measured in diameter fine water suppressor water ring or water ring delimited, and 7—Encapsulated nozzle, FIG. 5—1—Specification aqueous slurry non-pliable hose line-in measured in diameter from aqueous slurry electronic pump finite or variable control delimited not shown here; 2—specification aqueous slurry non-pliable hose line-in measured in diameter; 3—specification of pressurized air hose line-in measured in diameter from electronic air compressor pump finite or variable control delimited not shown here; 4—bi-interval valve measure in diameter not shown here; 5—specification of pressurized air hose line-in measured in diameter to vertical alignment encapsulated nozzle or standard alignment encapsulated nozzle not shown here; 6—vertical alignment encapsulated nozzle; and 7—vertical alignment shape nozzle measured in diameter sizes may vary not shown here, FIG. 6—1—Compressed air hose line-in measured in diameter, 2—Abrasive media hose line-in measured in diameter, 3—Compressed air hose line-in measured in diameter, 4—Abrasive media hose line-in measured in diameter, 5—Outer pressurized chamber, 6—Variable control regulator, 7—Inner pressurized chamber, 8—Variable control regulator, 9—Outer pressurized chamber, 10—Variable control regulator, 11—Inner pressurized chamber, 12—Variable control regulator, 13—Compressed air and abrasive media hose line-out 1 measured in diameter, 14—Compressed air and abrasive media hose line-out 2 measured in diameter, 15—Parallel phase regulator switch; elbow connectors; hose line-in measured in diameter, 16—Compressed air and abrasive media hose line-out 1-2 measured in diameter, 17—Water hose line-in measured in diameter fine water suppressor water ring or water ring delimited, and 18—Encapsulated nozzle, FIG. 7—1—Compressed air and abrasive media hose line-out measured in diameter, 2—Water hose line-in measured in diameter fine water suppressor water ring or water ring delimited, and 3—Standard nozzle measured in diameter sizes may vary, FIG. 8—1—Pressurized air and abrasive media hose line-in measured in diameter, 2—Encapsulated nozzle O-ring regulator pneumatic connector finite control, 3—Encapsulated nozzle pressurized chamber, 4—Encapsulated nozzle regulator 2 aperture measured in diameter, 5—Nozzle measured in diameter sizes may vary, and 6—Water hose line-in measured in diameter fine water suppressor water ring or water ring delimited, FIG. 9—1—Pressurized air and abrasive media hose line-in 1 measured in diameter, 2—Pressurized air and abrasive media hose line-in 2 measured in diameter, 3—Encapsulated nozzle O-ring regulator pneumatic connector finite control 1, 4—Encapsulated nozzle O-ring regulator pneumatic connector finite control 2, 5—Alternating encapsulated nozzle regulator 2 aperture 1 measured in diameter, 6—Alternating encapsulated nozzle regulator 2 aperture 2 measured in diameter, 7—Nozzle measured in diameter sizes may vary, 8—Water hose line-in measured in diameter fine water suppressor water ring or water ring delimited, 9—Pressurized chamber encapsulated nozzle 1, and 10—Pressurized chamber encapsulated nozzle 2, FIG. 10—1—Compressed air hose line-in measured in diameter; abrasive media hose line-in measured in diameter, 2—Encapsulated nozzle O-ring regulator pneumatic connector finite control, 3—Encapsulated nozzle pressurized chamber, 4—Encapsulated nozzle regulator 2 aperture measured in diameter, 5—Encapsulated nozzle measured in diameter sizes may vary, 6—Water hose line-in measured in diameter fine water suppressor water ring or water ring delimited, 7—Control valve abrasive media hose line-out measured in diameter, 8—Variable compressed air regulator hose line-in measured in diameter control valve, and 9—Control valve, FIG. 11—1—Compressed air hose line-in measured in diameter; abrasive media hose line-in measured in diameter, 2—Water hose line-in measured in diameter fine water suppressor water ring or water ring delimited, 3—Standard nozzle measured in diameter sizes may vary, 4—Control valve abrasive media hose line-out measured in diameter, 5—Variable compressed air regulator hose line-in measured in diameter control valve, and 6—Standard nozzle drilled bore-hole measured in diameter, and FIG. 12—1—Compressed air hose line-in measured in diameter, 2—Abrasive media hose line-in measured in diameter, 3—Outer pressurized chamber, 4—Variable control regulator, 5—Inner pressurized chamber, 6—Variable control regulator, 7—Compressed air line-out measure in diameter; abrasive media hose line-out measured in diameter, 8—Water hose line-in measured in diameter fine water suppressor water ring or water ring delimited, 9—Encapsulated nozzle, 10—Control valve abrasive media hose line-in measured in diameter, 11—Control valve, 12—Control valve abrasive media hose line-out measured in diameter, and 13—Variable compressed air regulator hose line-in measured in diameter control valve.

### DETAILED DESCRIPTION OF THE INVENTION

The Food Grade USDA Abrasive Media System is a mechanical means to safely clean, degrease, and coating removal from parts and substrates such as metals, alloys, copper, glass, unreinforced masonry URMs, stone, concrete, and asphalt. This is a light, easy to use, and extremely efficient air pressurized system that utilizes mechanical means Food Grade abrasive media water soluble, or non-water soluble, military specification—citric acid, food starch, and crushed walnut shells. The Food Grade USDA Abrasive Media System can apply FDA Approved toothpaste patents filed separately for dental and oral care subject to The American Dental Association ADA Seal of Acceptance Program.

All parts Food Grade USDA Abrasive Media System are built to specification towards the application specificity requirement and conform with the specified requirements to a unique ASTM International—Standards Worldwide identifier—sizes may vary.

Description of all parts making and using the same Food Grade USDA Abrasive Media System: 1. Food Grade and Fine Food Grade abrasive media airtight plastic injection molded preformed gravity feed free flow hopper comprising lid with release valve, air filter, silica gel slots, any combination of cone or parabolic shaped bottom variations for the Food Grade Abrasive Media consistency and size measured in grit, filtered air gravity feed outlet, or filtered air top feed outlet with or without gravity feed float; 2. Control valve, specification of negative pressurized air, specification of compressed air control, and specification of pneumatic hose line-in and line-out measured in diameter; 3. Specification pneumatic hose line-in measured in diameter, and specification of compressed air; 4. Outer pressurized chamber, specification of compressed air, and variable control regulator compressed air control; 5. Inner pressurized chamber, specification of compressed air, and variable control regulator compressed air control; 6. Specification pneumatic hose line-out measured in diameter; 7. Parallel phase regulator switch, specification of compressed air control, specification pneumatic hose line-in left and right measured in diameter, and elbow connectors left and right; 8. Encapsulated nozzle, specification of pressurized air, encapsulated nozzle O-ring regulator pneumatic connector finite control, encapsulated nozzle regulator 2 specification of compressed air regulated control, nozzle attachments measured in diameter, and aperture measured in diameter; or alternating encapsulated nozzle, alternating encapsulated nozzle two specifications of pressurized air, alternating encapsulated nozzle two O-ring regulators pneumatic connectors finite control, alternating encapsulated nozzle two regulators 2 specification of compressed air regulated control, nozzle attachments measured in diameter, and aperture measured in diameter; or encapsulated fan nozzle for applications requiring a wide stream of abrasive media usually for paint stripping, specification of pressurized air, encapsulated nozzle O-ring regulator pneumatic connector finite control, encapsulated nozzle regulator 2 specification of compressed air regulated control, fan nozzle attachments measured in diameter, and aperture measured in diameter; or shop vacuum pump wet and dry plastic injection molded preformed cone shaped and contoured vacuum attachments affixed at the end of the nozzle by way of a shop vacuum pump wet and dry hose line-in measured in diameter; 9. Wand with nozzle, siphon, or pump, and nozzle attachments measured in diameter; 10. Water suppressor supply of water hose line-in measured in diameter and fine water suppressor attachments water ring or water ring delimited; 11. Nozzle measured in diameter specification of pressurized stream; and 12. Plastic injection molded preformed parts cleaning cabinet system; diminishing gravity feed bottom and attachments of the parts cleaning cabinet system not shown here.

Description of all parts making and using the same Food Grade USDA Abrasive Media Zero Nozzle Aqueous Slurry System; 1—Specification aqueous slurry non-pliable hose line-in measured in diameter from aqueous slurry electronic pump finite or variable control delimited not shown here; specification of pressurized air hose line-in measured in diameter from electronic air compressor pump finite or variable control delimited not shown here; and specification of pressurized air hose line-in measured in diameter to vertical alignment encapsulated nozzle or standard alignment encapsulated nozzle not shown here; 2—bi-interval valve measured in diameter not shown here; 3—encapsulated nozzle vertical alignment shape nozzle measured in diameter or encapsulated nozzle standard alignment shape nozzle measured in diameter not shown here; 4—plastic injection molded preformed toothbrush wand and toothbrush bristles not shown here; and 5—Plastic injection molded preformed aqueous slurry dispenser not shown here.

The specification as set forth comprises electrical component systems rated alternating AC or direct current DC attached to a portable frame with handles and wheels not shown here: electric motor, air compressor, power supply, rated Volts alternating current AC; electric motor, vacuum pump, power supply rated Volts alternating current AC; electric motor oscillator, power supply rated Volts alternating current AC, or pneumatic oscillator, and pressurized variable control air hose line-in measured in diameter; electric motor, vacuum pump wet or dry, power supply rated Volts alternating current AC; and an aqueous slurry electronic motor pump finite or variable control delimited, power supply rated Volts alternating current AC, or direct current DC battery power not shown here; electronic air compressor pump finite or variable control delimited, power supply rated Volts alternating current AC, or direct current DC battery power not shown here.

The Food Grade abrasive media airtight plastic injection molded preformed gravity feed free flow hopper comprising lid with release valve, air filter, silica gel slots, and filtered air gravity feed outlet or filtered air top feed outlet is utilized specially packaged closed recycled refilled preparation Food Grade abrasive media water soluble, or non-water soluble, military specification—citric acid, food starch, crushed walnut shells, or FDA Approved toothpaste patents filed separately.

The Plastic Gravity Feed Free Flow Hopper variations for the Food Grade Abrasive Media consistency and size measured in grit may or may not sit in an oscillator not shown here that oscillates to and fro allowing the abrasive media to evenly distribute over the gravity feed bottom to an opening located in the center.

The Food Grade and Fine Food Grade abrasive media airtight plastic injection molded preformed gravity feed free flow hopper comprising lid with release valve, air filter, silica gel slots, any combination of cone or parabolic shaped bottom variations for the Food Grade Abrasive Media consistency and size measured in grit, filtered air gravity feed outlet, or filtered air top feed outlet with or without gravity feed float connects directly to the control valve FIGS. 11, 12, and 13 or to the control valve inside of a plastic injection molded preformed parts cleaning cabinet system not shown here combined with zero nozzle system encapsulated nozzle pressurized air, or zero nozzle system standard nozzle pressurized air whereby it can clean, remove contamination, and coating removal from parts and desired substrates such as metals, and alloys. Remaining debris are drawn into diminishing gravity feed bottom of the parts cleaning cabinet by way of a shop vacuum pump wet and dry hose line-in measured in diameter and attachments not shown here. A siphon, or pump and attachments are added to any nozzle for environmentally responsible liquid electrolyte rinsing and cleaning not shown here.

Abrasive media or FDA Approved toothpaste is drawn into the abrasive media line-in measured in diameter by way of negative pressurized air, transported directly into the control valve, and projected freely into the pressure system whereby it reaches specification diffusion and achieves equal particle distribution.

After the abrasive media exits the encapsulated nozzle or standard nozzle there it can be suppressed by water to clean and remove contamination from the desired substrate. The abrasive media and contamination can be vacuumed up by way of a shop vacuum pump wet and dry hose line-in measured in diameter plastic injection molded preformed cone shaped and contoured vacuum attachment affixed at the nozzle not shown here.

This system comprises air pressurized chambers, variable control regulation, and a dual regulation standard. This is a non-venturi system. Differential pressurization is the process obtaining diffusion and equal particle distribution for more than one or two or more pressurized streams combined FIGS. 4, 5, 7, 9, 10, 11, 12, and 13.

Differential pressurization is mathematically determined in cubic feet per minute CFM and pounds per square PSI of data sets from the following four systems: 1. Zero system specification air pressurization, control valve variable control regulation positive pressurization sum, and encapsulated nozzle specification 2 regulation or abrasive media standard nozzle measured in diameter specification of pressurized stream; or 2. Zero system specification air pressurization, control valve variable control regulation positive pressurization sum, and standard nozzle measured in diameter specification of pressurized stream; or 3. Differential Pressurized Variable Control Regulation Abrasive Media One Stage System; specification air pressurization, control valve variable control regulation positive pressurization sum, and encapsulated nozzle specification 2 regulation or abrasive media standard nozzle measured in diameter specification of pressurized stream; or 4. Differential Pressurized Variable Control Regulation Abrasive Media System; specification air pressurization, control valve variable control regulation positive pressurization sum, and encapsulated nozzle specification 2 regulation or abrasive media standard nozzle measured in diameter specification of pressurized stream; and Zero Nozzle Aqueous Slurry System requires no differential pressurization calculation as the exception to the rule.

This system comprises an encapsulated nozzle for advanced efficiency of operation FIG. 9, a standard nozzle FIG. 8, an alternating encapsulated pressurized nozzle for applications requiring two volumes of abrasive media FIG. 10, in addition to an encapsulated fan nozzle measured in diameter for applications requiring a wide stream of abrasive media usually for paint stripping sizes may vary not shown here.

With the addition of a parallel phase regulator switch this system can expand to operate parallel capacities of abrasive media for applications without interval when necessary FIG. 7.

1. Description of all parts making and using the same Food Grade USDA Abrasive Media System. 1. Food Grade and Fine Food Grade abrasive media airtight plastic injection molded preformed gravity feed free flow hopper comprising lid with release valve, air filter, silica gel slots, any combination of cone or parabolic shaped bottom variations for the Food Grade Abrasive Media consistency and size measured in grit, filtered air gravity feed outlet, or filtered air top feed outlet with or without gravity feed float; 2. Control valve, specification of negative pressurized air, specification of compressed air control, and specification of pneumatic hose line-in and line-out measured in diameter; 3. Specification pneumatic hose line-in measured in diameter, and specification of compressed air; 4. Outer pressurized chamber, specification of compressed air, and variable control regulator compressed air control; 5. Inner pressurized chamber, specification of compressed air, and variable control regulator compressed air control; 6. Specification pneumatic hose line-out measured in diameter; 7. Parallel phase regulator switch, specification of compressed air control, specification pneumatic hose line-in left and right measured in diameter, and elbow connectors left and right; 8. Encapsulated nozzle, specification of pressurized air, encapsulated nozzle O-ring regulator pneumatic connector finite control, encapsulated nozzle regulator 2 specification of compressed air regulated control, nozzle attachments measured in diameter, and aperture measured in diameter; or alternating encapsulated nozzle, alternating encapsulated nozzle two specifications of pressurized air, alternating encapsulated nozzle two O-ring regulators pneumatic connectors finite control, alternating encapsulated nozzle two regulators 2 specification of compressed air regulated control, nozzle attachments measured in diameter, and aperture measured in diameter; or encapsulated fan nozzle for applications requiring a wide stream of abrasive media usually for paint stripping, specification of pressurized air, encapsulated nozzle O-ring regulator pneumatic connector finite control, encapsulated nozzle regulator 2 specification of compressed air regulated control, fan nozzle attachments measured in diameter, and aperture measured in diameter; or shop vacuum pump wet and dry plastic injection molded preformed cone shaped and contoured vacuum attachments affixed at the end of the nozzle by way of a shop vacuum pump wet and dry hose line-in measured in diameter; 9. Wand with nozzle, siphon, or pump, and nozzle attachments measured in diameter; 10. Water suppressor supply of water hose line-in measured in diameter and fine water suppressor attachments water ring or water ring delimited; 11. Nozzle measured in diameter specification of pressurized stream; and 12. Plastic injection molded preformed parts cleaning cabinet system; diminishing gravity feed bottom and attachments of the parts cleaning cabinet system not shown here.

2. Description of all parts making and using the same Food Grade USDA Abrasive Media Zero Nozzle Aqueous Slurry System; 1—Specification aqueous slurry non-pliable hose line-in measured in diameter from aqueous slurry electronic pump finite or variable control delimited not shown here; specification of pressurized air hose line-in measured in diameter from electronic air compressor pump finite or variable control delimited not shown here; and specification of pressurized air hose line-in measured in diameter to vertical alignment encapsulated nozzle or standard alignment encapsulated nozzle not shown here; 2—bi-interval valve measured in diameter not shown here; 3—encapsulated nozzle vertical alignment shape nozzle measured in diameter or encapsulated nozzle standard alignment shape nozzle measured in diameter not shown here; 4—plastic injection molded preformed toothbrush wand and toothbrush bristles not shown here; and 5—Plastic injection molded preformed aqueous slurry dispenser not shown here.

3. The specification as set forth comprises electrical component systems rated alternating AC or direct current DC attached to a portable frame with handles and wheels not shown here: electric motor, air compressor, power supply, rated Volts alternating current AC; electric motor, vacuum pump, power supply rated Volts alternating current AC; electric motor oscillator, power supply rated Volts alternating current AC, or pneumatic oscillator, and pressurized variable control air hose line-in measured in diameter; electric motor, vacuum pump wet or dry, power supply rated Volts alternating current AC; and an aqueous slurry electronic motor pump finite or variable control delimited, power supply rated Volts alternating current AC, or direct current DC battery power not shown here; electronic air compressor pump finite or variable control delimited, power supply rated Volts alternating current AC, or direct current DC battery power not shown here.
